(19) United States
(12) Patent Application Publication
(10) Pub. No.: US 2012/0287665 A1
(43) Pub. Date: Nov. 15, 2012

(54) LIGHT GUIDE PLATE, SURFACE LIGHT SOURCE DEVICE, TRANSMISSION-TYPE IMAGE DISPLAY DEVICE, METHOD OF DESIGNING LIGHT DISTRIBUTION PATTERN FOR LIGHT GUIDE PLATE, AND METHOD OF MANUFACTURING LIGHT GUIDE PLATE

(75) Inventors: Kentarou HYAKUTA, Niihama-shi (JP); Yoshihisa SHIMADA, Fukui-shi (JP); Hidekazu SHIOMI, Fukui-shi (JP)

(73) Assignees: SEIREN CO., LTD., Fukui-shi (JP); SUMITOMO CHEMICAL COMPANY, LIMITED, Tokyo (JP)

(21) Appl. No.: 13/413,115

(22) Filed: Mar. 6, 2012

(30) Foreign Application Priority Data
May 13, 2011 (JP) P2011-108476

(51) Int. Cl. F21V 8/00; B05D 5/06

(52) U.S. Cl. 362/602; 362/341; 362/624; 427/162

(57) ABSTRACT

A light guide plate 1 according to an embodiment of the present invention is a light guide plate in which light reflective dot are formed on at least one surface S2 of a light guide substrate 11, wherein the plurality of light reflective dot 12 are formed on grid points for printing targets, the grid points being regularly arrayed in a two-dimensional pattern, in each of individual regions obtained by dividing the at least one surface S2 of the light guide substrate 11 into the plurality of regions, and wherein some of the light reflective dot 12 are eliminated in each of the individual regions.

### BACKGROUND OF THE INVENTION

1. Field of the Invention

The present invention relates to a light guide plate, a surface light source device, a transmission-type image display device, a method of designing a light distribution pattern for the light guide plate, and a method of manufacturing the light guide plate.

2. Related Background Art

A transmission-type image display device such as a liquid crystal display device generally has a surface light source device for supplying surface light using a light guide plate, as a backlight. Types of surface light source devices include a direct backlight type in which the light source is located on the back side of the light guide plate, and an edge light type in which the light source is located along a side face of the light guide plate. The edge light system is advantageous in terms of reduction in thickness of the image display device.

In the surface light source device of the edge light type, the light incident through the end face of the light guide plate is reflected and diffused (or scattered) by action of a light distribution pattern provided on the rear face of the light guide plate (e.g., a light distribution pattern comprised of light reflective dot), and light components with angles of not less than the critical angle is emitted from an exit face of the light guide plate, thereby supplying the planar light. For making the luminance of its exit face uniform, the light guide plates described in Patent Literatures 1 and 2 are provided with such gradation as to change the density of the light distribution pattern from coarse to dense with distance from the light source.

Patent Literature 1 also discloses a technique of forming the light distribution pattern of the dot pattern of this kind by discharge of liquid droplets (e.g., by ink-jet printing). For example, the ink-jet printing technology is sometimes carried out using an array of multiple ink-jet heads, in order to reduce the printing takt time.
Patent Literature 1: Japanese Patent Application Laid-open No. 2004-240294
Patent Literature 2: Japanese Patent Application Laid-open No. 2008-27609

### SUMMARY OF THE INVENTION

However, when the pattern is printed by the array of ink-jet heads, there appears linear luminance nonuniformity (striped unevenness) at connections between the ink-jet heads, because of their installation accuracy and position adjustment accuracy. Concerning this point, a lot of time and efforts become necessary for adjustment of the positions of the ink-jet heads with higher accuracy.

It is therefore an object of the present invention to provide a light guide plate, a surface light source device, a transmission-type image display device, a method of designing a light distribution pattern for the light guide plate, and a method of manufacturing the light guide plate, enabling reduction in linear luminance nonuniformity at the connections between the ink-jet heads.

The inventors conducted elaborate research and discovered that the linear luminance nonuniformity at the connections between the ink-jet heads can be reduced by eliminating some of the light reflective dot in the light distribution pattern.

Therefore, a light guide plate according to the present invention is a light guide plate in which light reflective dot are formed on at least one surface of a light guide substrate, wherein the plurality of light reflective dot are formed on grid points for printing targets, the grid points being regularly arrayed in a two-dimensional pattern, in each of individual regions obtained by dividing the at least one surface of the light guide substrate into the plurality of regions, and wherein some of the light reflective dot are eliminated in each of the individual regions.

Since some of the light reflective dot regularly arrayed in the two-dimensional pattern are eliminated in this light guide plate, the linear luminance nonuniformity can be reduced at the connections between the ink-jet heads.

An eliminating rate of some of the light reflective dot is preferably in the range of 1% to 30% of the number of the grid points. As the eliminating rate of light reflective dot increases, the luminance nonuniformity becomes conspicuous in regions where a coverage of the light distribution pattern is low as on the light incident side near the light source. Since the eliminating rate of light reflective dot is relatively small, 1% to 30%, in the foregoing configuration, the linear luminance nonuniformity can be reduced at the connections between the ink-jet heads, without degradation of uniformity of luminance on the light incident side.

Preferably, the plurality of light reflective dot include light reflective dot having two or more types of sizes, and the two or more types of light reflective dot are arranged in an irregular order. Since the light reflective dot having the two or more types of sizes are arranged in the irregular order in this configuration, it is feasible to decrease change in gradation due to the light reflective dot. Accordingly, nonuniformity of luminance can be reduced in the regions where the coverage of the light distribution pattern is low as on the light incident side near the light source.

A designing method of a light distribution pattern for a light guide plate according to the present invention is a method of designing a light distribution pattern consisting of light reflective dot formed on at least one surface of a light guide substrate, comprising: a coverage setting step of dividing the at least one surface of the light guide substrate into a plurality of regions and setting a coverage for each of the individual regions obtained by the dividing; a grid point setting step of setting grid points for printing targets, the grid points being regularly arrayed in a two-dimensional pattern, for each of the individual regions; a grid point calculation step of calculating a number of the grid points, for each of the individual regions; an elimination number setting step of setting a size of the light reflective dot to be formed on the grid points, and an elimination number of the light reflective dot, based on the coverage and the number of grid points, for each of the individual regions; and an arrangement step of arranging a plurality of light reflective dot on the grid points so as to eliminate some of the light reflective dot, based on the result obtained in the elimination number setting step.

In this designing method of the light distribution pattern for the light guide plate, some of the light reflective dot regularly arrayed in the two-dimensional pattern are also eliminated as described above; therefore, the linear luminance nonuniformity can be reduced at the connections between the ink-jet heads.

Preferably, the elimination number setting step comprises setting the elimination number of the light reflective dot in such a manner that an eliminating rate of some of the light reflective dot falls in the range of 1% to 30% of the number of the grid points. Since the eliminating rate of light reflective dot is relatively small, 1% to 30%, in this configuration as described above, the linear luminance nonuniformity can be reduced at the connections between the ink-jet heads, without degradation of uniformity of luminance on the light incident side.

Preferably, the elimination number setting step comprises setting the size of the light reflective dot to be formed on the grid points, in such a manner that the plurality of light reflective dot include light reflective dot having two or more types of sizes, and the arrangement step comprises arranging the plurality of light reflective dot in a such a manner that the two or more types of light reflective dot are arranged in an irregular order. Since the light reflective dot having the two or more types of sizes are arranged in the irregular order in this configuration as described above, it is feasible to decrease change in gradation due to the light reflective dot. Accordingly, the luminance nonuniformity can be reduced in the regions where the coverage of the light distribution pattern is low as on the light incident side near the light source.

A manufacturing method of a light guide plate according to the present invention is a method of manufacturing a light guide plate in which a light distribution pattern consisting of light reflective dot is formed on at least one surface of a light guide substrate, using a printing device which has two or more units in which printing portions for printing are arrayed, and in which the units are arranged in an array direction of the printing portions, wherein the light distribution pattern is designed by the method of designing the light distribution pattern for the light guide plate as set forth, and wherein the light distribution pattern is printed onto the light guide substrate by the printing portions of the units, while implementing relative movement of the units to the light guide substrate.

Since this manufacturing method of the light guide plate employs the aforementioned designing method of the light distribution pattern for the light guide plate, the linear luminance nonuniformity can be reduced at the connections between the ink-jet heads.

The printing portions are nozzles, the units are ink-jet heads having an array of the nozzles, and the light reflective dot are comprised of a UV (ultraviolet) curing type ink-jet ink for the light guide plate.

Another light guide plate according to the present invention comprises the light distribution pattern designed by the aforementioned designing method of the light distribution pattern for the light guide plate. Still another light guide plate according to the present invention is manufactured by the aforementioned manufacturing method of the light guide plate.

In these light guide plates, some of the light reflective dot regularly arrayed in the two-dimensional pattern are eliminated as described above and, therefore, the linear luminance nonuniformity can be reduced at the connections between the ink-jet heads.

A surface light source device according to the present invention is a surface light source device of an edge light type comprising: the aforementioned light guide plate; and a light source for supplying a light to the end face of the light guide plate. Since this surface light source device comprises the aforementioned light guide plate, nonuniformity of luminance is reduced in the surface light source device of the edge light type.

A transmission-type image display device according to the present invention comprises: the aforementioned surface light source device; and a transmission-type image display unit arranged opposite to an exit face of the surface light source device. Since this transmission-type image display device comprises the surface light source device having the aforementioned light guide plate, nonuniformity of luminance is reduced in the transmission-type image display device.

The present invention allows the linear luminance nonuniformity to be easily reduced at the connections between the ink jet heads. Nonuniformity of luminance is reduced in the surface light source device of the edge light type using the light guide plate and in the transmission-type image display device using the surface light source device of the edge light type.

### BRIEF DESCRIPTION OF THE DRAWINGS

FIG. 1 is a cross-sectional view showing a transmission-type image display device having an embodiment of a light guide plate according to the present invention.

FIG. 2 is a plan view of the light guide plate as viewed from the back side.

FIG. 3 is a drawing showing details of an embodiment of a light distribution pattern consisting of a plurality of reflective dot.

FIG. 4 is a drawing showing an embodiment of a coverage setting step in a designing method of a light distribution pattern for a light guide plate according to the present invention.

FIG. 5 is a drawing showing an embodiment of a grid point setting step in the designing method of the light distribution pattern for the light guide plate according to the present invention.

FIG. 6 is a drawing showing a modification example of the grid point setting step shown in FIG. 5.

FIG. 7 is a drawing showing a modification example of the grid point setting step shown in FIG. 5.

FIG. 8 is a drawing showing a modification example of the grid point setting step shown in FIG. 5.

FIG. 9 is a drawing showing an embodiment of a grid point calculation step in the designing method of the light distribution pattern for the light guide plate according to the present invention.

FIG. 10 is a drawing showing an embodiment of an elimination number setting step and an arrangement step in the designing method of the light distribution pattern for the light guide plate according to the present invention.

FIG. 11 is a perspective view showing an embodiment of a manufacturing method of light guide plate.

FIG. 12 is a schematic diagram showing a conventional printing method.

FIG. 13 is a schematic diagram showing a printing method according to an embodiment of the present invention.

FIG. 14 is a drawing showing a modification example of a light guide plate according to the present invention.

FIG. 15 is a drawing showing a part of a light distribution pattern in each of light guide plates according to examples of the present invention.

### DESCRIPTION OF THE PREFERRED EMBODIMENTS

The preferred embodiments of the present invention will be described below in detail with reference to the drawings. In the drawings identical or equivalent portions are denoted by the identical reference characters.

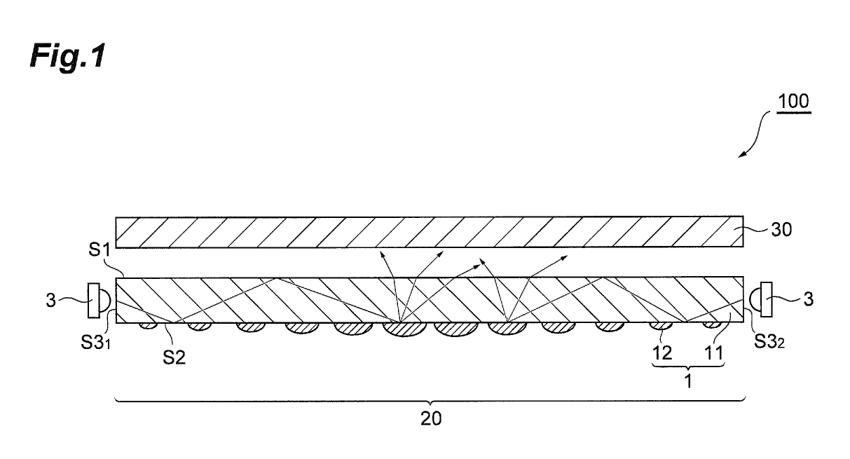

FIG. 1 is a cross-sectional view showing a transmission-type image display device comprising an embodiment of a light guide plate according to the present invention. The transmission-type image display device 100 illustrated in FIG. 1 is mainly constructed by a surface light source device 20 and a transmission-type image display unit 30. The surface light source device 20 is an edge-light type surface light source device including a light guide plate 1 having a light guide substrate 11 and light sources 3 which is provided to the side of the light guide plate 1 and which supplies light to the light guide plate 1.

The light guide substrate 11 has an approximately cuboid shape. The light guide substrate 11 has an exit face S1, a rear face S2 in the opposite side of the exit face S1, and four end faces S3₁ to S3₄ that intersect the exit face S1 and the rear face S2. In the present embodiment, the four end faces S3₁ to S3₄ are approximately orthogonal to the exit face S1 and the rear face S2.

The light guide substrate 11 is comprised of an optically transparent material and is preferably a poly(meth)alkyl acrylate resin sheet, a polystyrene sheet or a polycarbonate-based resin sheet, and among then, polymethyl methacrylate resin sheet (PMMA resin sheet) is preferable. The light guide substrate 11 may also contain diffusing particles. The surface (exit face S1) in the opposite side of a surface (rear face S2) of the light guide substrate 11, on which reflective dots 12 are formed, may be a flat surface as described in the present embodiment, but may also have a shape of concavity and covexity. The light guide substrate 11 preferably has a thickness of 1.0 mm to 4.5 mm.

The rear face S2 of the light guide substrate 11 may be a surface almost entirely subjected to liquid repellent treatment. The liquid repellent treatment applied to the rear face S2 is a liquid repellent treatment in which a drop of water dropped on the rear face S2 has a contact angle of 80 to 130 degrees, preferably a contact angle of 85 to 120 degrees, or more preferably a contact angle of 90 to 110 degrees. In the present embodiment, the contact angle refers to a static contact angle.

A plurality of reflective dot 12 are formed on the rear face S2 of the light guide substrate 11. Namely, the light guide plate 1 further has the plurality of reflective dot 12 provided on the rear face S2. The maximum thickness of each reflective dot 12 is preferably 20 μm or less or more preferably 15 μm or less.

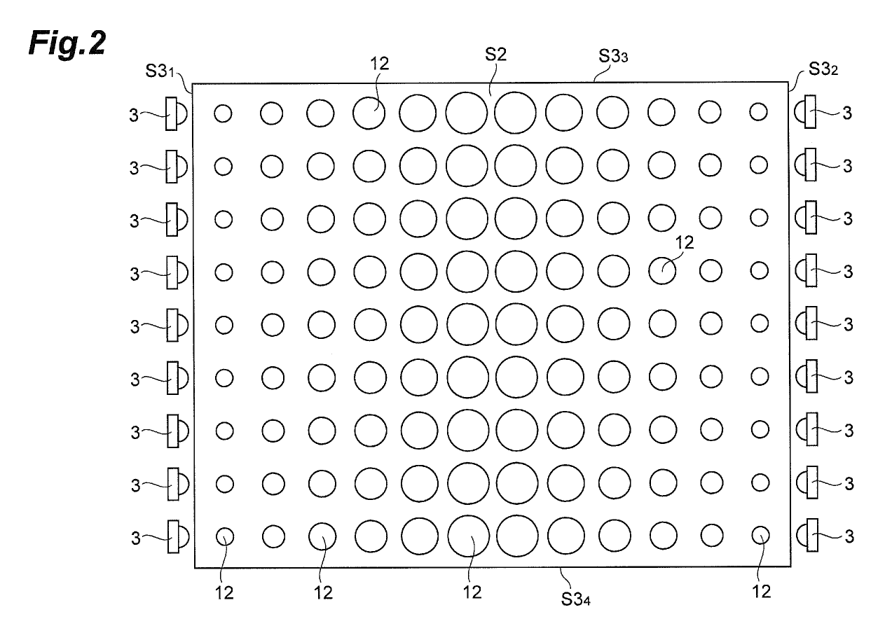

As shown in FIG. 2, the plurality of reflective dots 12 are arranged separated from each other on the rear face S2. FIG. 2 is a plan view of the light guide plate as seen from the side of the rear face. FIG. 2 also shows the light sources 3 for the sake convenience of explanation. As shown in FIG. 2, the reflective dot 12 are small on the light incident sides near the light sources 3 and become larger with distance from the light sources 3. Since the reflective dot 12 are formed at grid points regularly arrayed in a two-dimensional pattern across the entire area of the rear face S2, the coverage of the reflective dot 12 is low on the light incident sides near the light sources 3 and becomes higher with distance from the light sources 3. The reflective dot 12 are preferably not connected with each other, but they are sometimes connected with each other in fact. In FIG. 2, the sizes, the number, etc. of the reflective dot 12 are modified for the sake of convenience of explanation, the number and arrangement pattern of reflective dots 12 are adjusted so that a uniform planar light is efficiently emitted from the exit face S1.

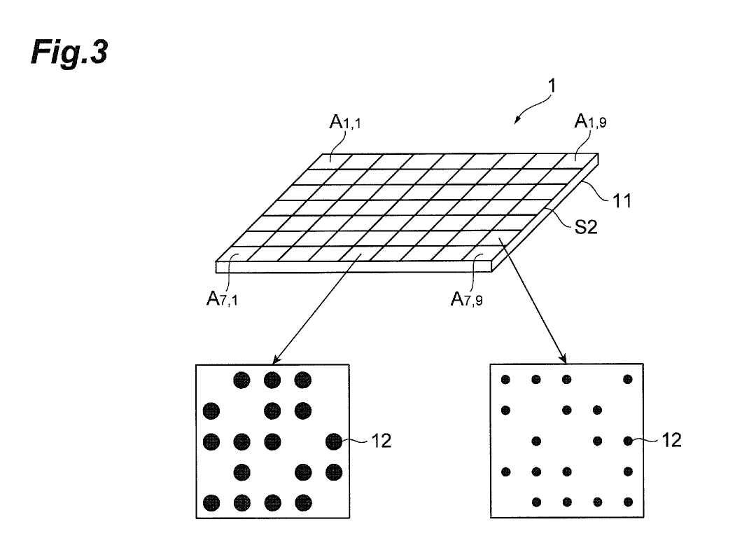

FIG. 3 is a drawing showing details of a light distribution pattern by the reflective dot 12. In the present embodiment, as shown in FIG. 3, the rear face S2 of the light guide substrate 11 is divided into 7×9 regions A_{1,1} to A_{7,9} and the size and others of reflective dot 12 are designed for each individual region A_{m,n} (where m is an integer of 1 to 7 both inclusive and n an integer of 1 to 9 both inclusive). In the individual region A_{m,n}, a plurality of light reflective dot 12 are formed on grid points for printing targets which are grid points regularly arrayed in a two-dimensional pattern, and some light reflective dot are eliminated from the plurality of light reflective dot 12. An eliminating rate of the light reflective dot 12 is set in the range of 1% to 30% of the number of grid points.

Referring back to FIGS. 1 and 2, the light sources 3 is arranged lateral to a pair of end faces S3₁, S3₂ which oppose each other. While the light sources 3 may be linear light sources such as a cold cathode fluorescent lamp (CCFL), it is preferable that the light source 3 is a point light source such as an LED. In this case, as shown in FIG. 2, a plurality of point light sources are arranged along two sides that oppose each other among four sides constituting, for example, a rectangular rear face S2 of the light guide substrate 11. Combining reflective dots 12 formed by an ink-jet ink (to be described later) and LEDs is particularly advantageous for the purpose of obtaining natural color tone light.

As shown in FIG. 1, the transmission-type image display unit 30 is arranged so as to oppose the light guide plate 1 on the side of the exit face S1 of the light guide plate 1. For example, the transmission-type image display unit 30 is a liquid crystal display unit having a liquid crystal cells.

In the configuration described above, light emitted from the light sources 3 is incident to the light guide substrate 11 from the end faces S3₁, S3₂. The light incident to the light guide substrate 11 is irregularly reflected by the reflective dots 12 and primarily emitted from the exit face S1. The light emitted from the exit face S1 is supplied to the transmission-type image display unit 30. The number and arrangement pattern of reflective dots 12 are adjusted so that a uniform planar light is efficiently emitted from the exit face S1.

Next, a method of designing the light distribution pattern of the light guide plate 1 will be described.

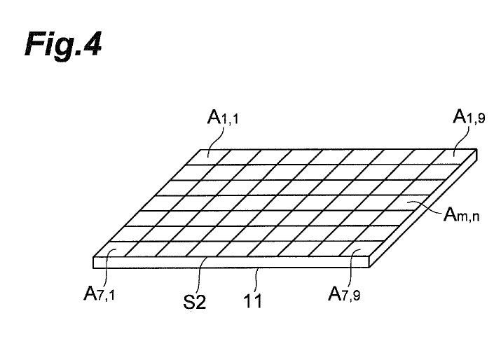

First, as shown in FIG. 4, the rear face S2 of the light guide substrate 11 is divided, for example, into 7×9 regions A_{1,1} to A_{7,9} and a coverage is set for each individual region A_{m,n} (where m is an integer of 1 to 7 both inclusive and n an integer of 1 to 9 both inclusive). Specifically, the coverages are set so as to efficiently emit uniform surface light from the exit surface (coverage setting step).

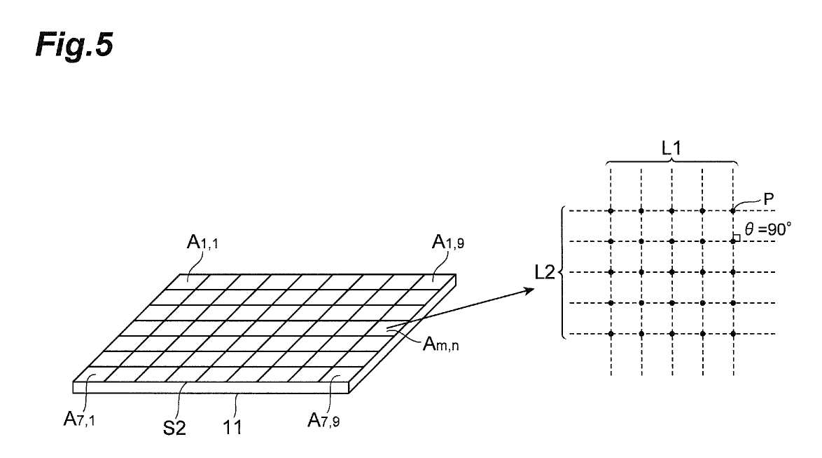

Next, as shown in FIG. 5, grid points P regularly arrayed in a two-dimensional pattern, which are grid points for printing targets of light reflective dot, are set for each individual region A_{m,n}. Specifically, the grid points P are defined as intersections between a first straight line group L1 of straight lines parallel to each other, and a second straight line group L2 of straight lines parallel to each other. In FIG. 5, the first line group L1 and the second line group L2 are perpendicular to each other (grid point setting step).

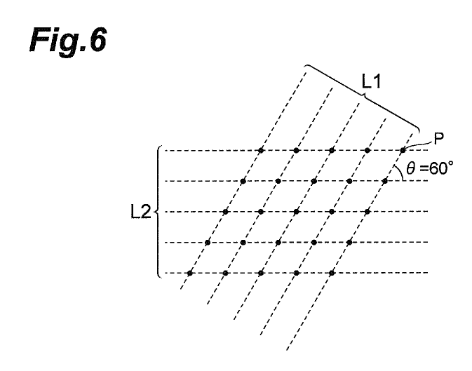

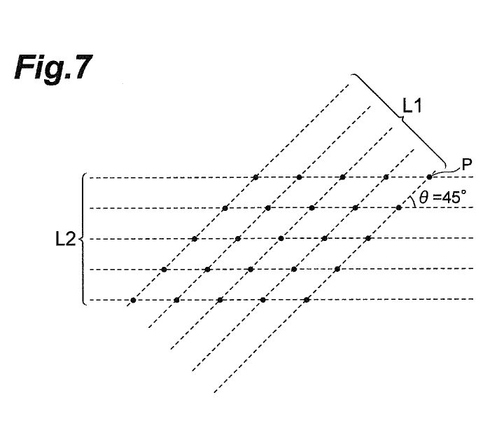

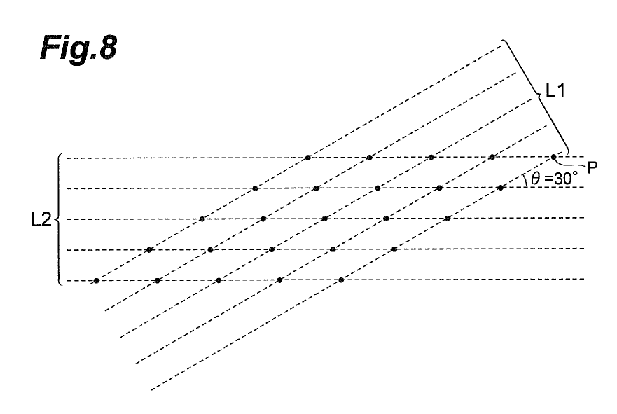

The first line group L1 and the second line group L2 do not always have to be perpendicular to each other, as shown in FIGS. 6 to 8. An intersecting angle θ between the first line group L1 and the second line group L2 is in the range of 30 to 150 degrees and is, preferably, in the range of 60 to 120 degrees. When the intersecting angle θ between the first line group L1 and the second line group L2 is set in the range of 30 to 150 degrees, the light reflective dot can be arranged as separated from each other and the light distribution pattern by the light reflective dot can be printed with a high coverage. As a result, it is feasible to enhance the luminance of output light from the surface light source device.

The distance between straight lines in each of the first line group L1 and the second line group L2 is in the range of 40 μm to 200 μm, preferably in the range of 50 μm to 180 μm, and more preferably in the range of 60 μm to 120 μm. When the distance between straight lines is set in the range of 40 μm to 200 μm, the light reflective dot can be arranged as separated from each other and the light distribution pattern by the light reflective dot can be printed with a higher coverage. As a result, it is feasible to enhance the luminance of output light from the surface light source device.

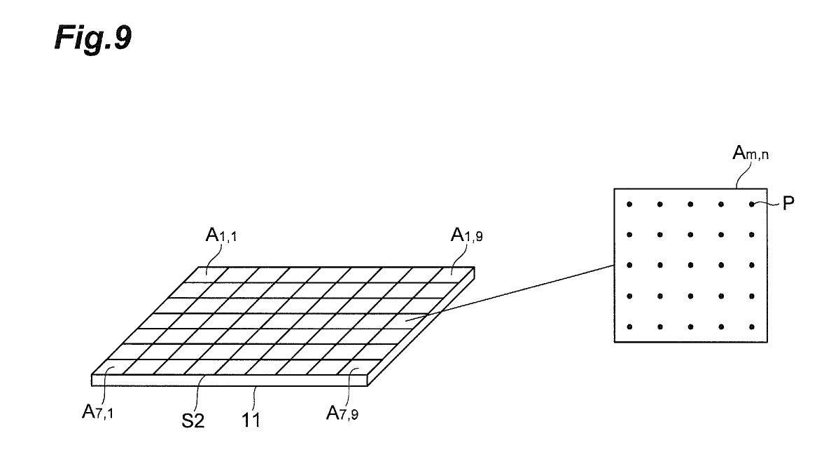

Next, as shown in FIG. 9, the set number of grid points P is calculated in each individual region A_{m,n}. In the present embodiment, the number of grid points P is 5×5 (grid point calculation step).

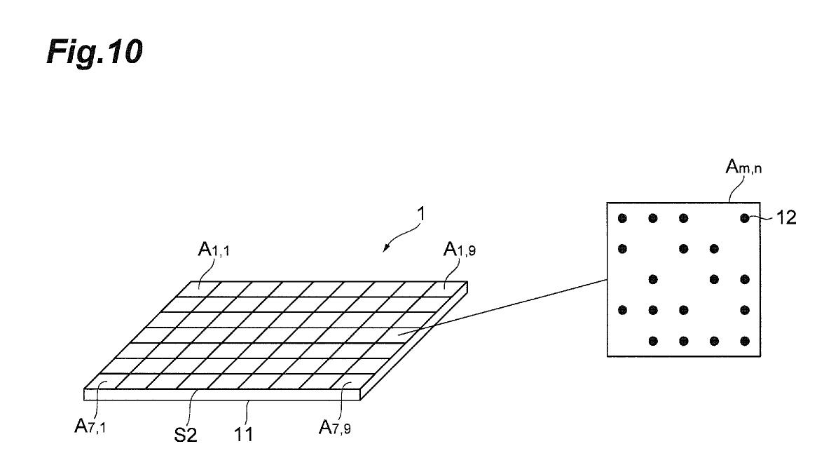

Next, as shown in FIG. 10, the size of light reflective dot 12 to be formed on the grid points P, and the elimination number of light reflective dot (i.e., the number of light reflective dot 12) are determined based on the set coverage and the number of grid points P, for each individual region A_{m,n} (elimination number setting step).

Next, for each individual region A_{m,n}, a plurality of light reflective dot 12 are arranged on the grid points P so that some of the light reflective dot 12 are eliminated, based on the result obtained in the elimination number setting step (arrangement step).

Next, a method of manufacturing the light guide plate 1 will be described using the light distribution pattern designed by the designing method of the light distribution pattern for the light guide plate 1.

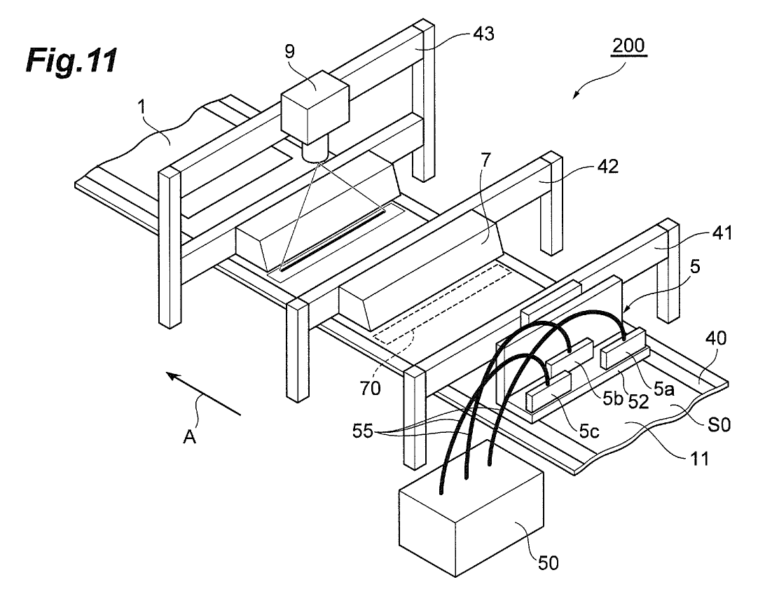

An device 200 illustrated in FIG. 11 for manufacturing the light guide plate is structured by transporting means 40 for transporting the light guide substrate 11, an ink-jet head section 5, a UV lamp 7 and an inspection device 9. The ink-jet head section 5, the UV lamp 7 and the inspection device 9 are arranged sequentially in this order from the upstream side in a moving direction A of the light guide substrate 11.

The light guide substrate 11 is continuously or intermittently transported along the direction A by the transporting means 40. The light guide substrate 11 may also be previously cut so as to match the size of the light guide plate to be manufactured, or may also be cut after the reflective dots 12 have been formed on the long the light guide substrate 11. The transporting means 40 in the present embodiment is a table shuttle, but is not limited to it, and may also be, for instance, a belt conveyor, a rollers or an air levitation transfer.

A droplet ink-jet ink is deposited on the surface S0 of the light guide substrate 11 by the ink-jet head section 5 supported by a support unit 41, so as to form a pattern comprised of the dot-shaped ink. In doing so, the printing of the pattern is performed so that the droplet-shaped inkjet ink deposited on the surface S0 are separated from each other.

The ink-jet head section 5 has a plurality of nozzles arrayed and fixed in one row or more rows in the whole width direction (direction perpendicular to A) of a region in which the reflective dots are formed on the surface of the light guide substrate 11, so as to oppose to the rear face S2 of the light guide substrate 11. The ink in the droplet state, which has been discharged from the plurality of the nozzles by an ink jet system, is simultaneously and collectively printed in the whole width direction of the light guide substrate 11. The ink is printed preferably while the light guide substrate 11 is continuously moved at a fixed speed. Alternatively, the ink can also be efficiently printed so as to have a pattern composed of a plurality of rows of dots, by repeating an operation of printing the ink in a state in which the light guide substrate 11 is stopped, moving the light guide substrate 11 to a next printing position, and stopping the movement.

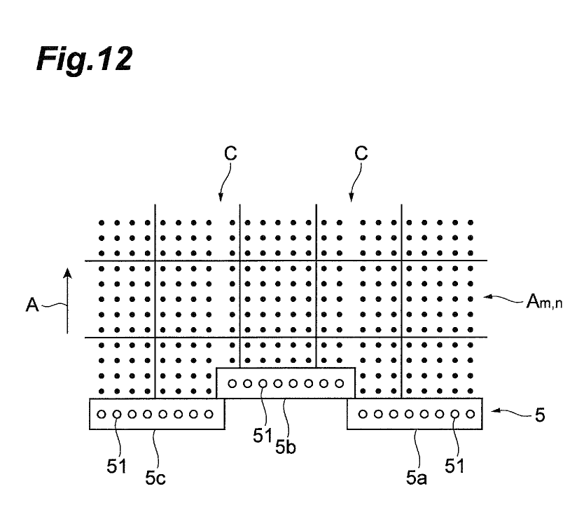

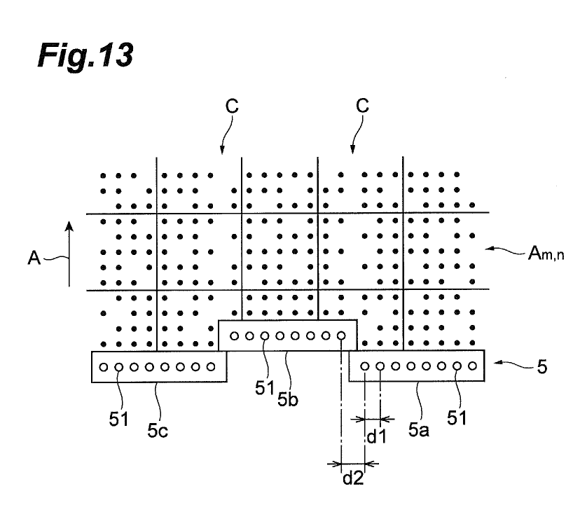

The moving speed of the light guide substrate 11 is controlled so that the ink may be printed appropriately. In the case of the present embodiment, as shown in FIGS. 12 and 13, the ink-jet head section 5 is composed of a plurality of ink-jet heads (units) 5a-5c each having a plurality of nozzles 51. The plurality of these ink-jet heads 5a-5c are arrayed in the direction perpendicular to the conveying direction A of transporting the light guide substrate 11 and are coupled to each other through a fixing member 52 (cf. FIG. 11) in such a manner that ends thereof overlap each other in the conveying direction A.

In the case of the present embodiment, the ink can be collectively printed in the whole width direction of the light guide substrate 11, in a state in which the plurality of the nozzles of the ink-jet head section 5 are fixed. Thereby, the productivity for the light guide plate is significantly enhanced compared to the case in which the ink is subsequently printed while a movable nozzle is moved along the width direction of the light guide substrate 11.

When a large-sized light guide plate 1 having the light guide substrate 11 with the length of 200 mm or longer and 1000 mm or shorter in a short side is manufactured, in particular, an effect of enhancing the productivity according to the method of the present embodiment is large. Furthermore, according to the ink-jet method, even the fine reflective dots 12 having, for instance, the largest diameter of 100 μm or less can be easily and accurately formed. When the light guide substrate 11 is thin, the reflective dots 12 can be seen through from the exit face S1 side; but the phenomenon can be prevented by making the reflective dots small.

The nozzles of the ink-jet head section 5 is connected to an ink supply unit 50 through a duct 55. The ink supply unit 50 has, for instance, an ink tank in which an ink has been accommodated and a pump for sending the ink out. The plurality of the duct 55 may be connected to a single ink tank, or may also be connected to a plurality of ink tanks, respectively.

The ink-jet ink which is used in ink jet printing to form the reflective dots 12 is an ultraviolet curing type ink which includes a pigment, a photopolymerizable component and a photopolymerization initiator, or may be an aqueous ink, a solvent ink, or the like. The ink-jet ink does not always have to contain a pigment.

The pigment is preferably at least any one of calcium carbonate particles, barium sulfate particles, and titanium dioxide particles. Respective cumulative 50% particle size D50 of the calcium carbonate particles, the barium sulfate particles, and the titanium dioxide particles range from 50 to 3000 nm, more preferably from 100 to 1,500 nm, or even more preferably from 300 to 600 nm. Calcium carbonate particles, barium sulfate-particles, and titanium dioxide particles having the cumulative 50% particle size D50 in a range from 50 to 3,000 nm can be obtained by appropriately selecting a product on the basis of a particle size distribution from commercialized products. The content ration of the pigment in the ink is usually appropriately 0.5 to 15.0 mass % with reference to the total mass of the ink. An ink using a pigment that is at least any one of calcium carbonate particles, barium sulfate particles, and titanium dioxide particles is an ink using an inorganic substance. When considering a preservation stability or, in other words, an inorganic pigment sedimentation property of such an ink using an inorganic substance, an ink that uses calcium carbonate particles whose specific gravity is the smallest among the three particles as a pigment is most favorable.

A viscosity of the ink-jet ink at 50±10° C. is preferably 5.0 to 15.0 mPa·s, and more preferably 8.0 to 12.0 mPa·s. The viscosity of the ink-jet ink can be adjusted, for instance, by weight average molecular weight and/or content ratio of the aliphatic urethane (meth)acrylate. When the weight average molecular weight and the content ratio of the aliphatic urethane (meth)acrylate increase, the viscosity of ink tends to increase.

A surface tension of the ink-jet ink at 25.0° C. is preferably 25.0 to 45.0 mJ/m², and more preferably of 25.0 to 37.0 mJ/m². The surface tension of the ink-jet ink can be adjusted, for instance, by blending a silicon-based surface active agent and a fluorine-based surface active agent into the ink.

The printed ink is cured in a region 70 by a UV lamp 7 which is supported by a support unit 42. Thereby, the reflective dots 12 constructed by the cured ink is formed.

After that, the light guide plate 1 is obtained through the step in which an inspection device 9 supported by a support unit 43 inspects the state of the formed reflective dots 12. The light guide plate 1 is cut off into a desired size, as needed. The light guide plate does not necessarily need to be continuously inspected by the inspection device disposed in the downstream side of the ink-jet head section, as in the present embodiment, but the light guide plate can be also inspected off-line by an inspection device which has been separately prepared. Alternatively, the inspection step of the light guide plate by the inspection device can be occasionally omitted.

Normally, a printing pattern of ink that becomes the reflective dots 12 is designed to a desired pattern in which a uniform planar light is efficiently emitted from the exit face S1. In this case, since an arrangement pattern of the plurality of reflective dots 12 more or less assumes a desired pattern, the light supplied from the light sources 3 to the light guide substrate 11 can be effectively extracted from the light-exit face S1. As a result, light can be emitted from the light-exit face S1 of the light guide plate 1 at a higher luminance. In addition, since an arrangement pattern of the reflective dots 12 is the desired pattern as described above, light can be emitted approximately uniformly from the light-exit face S1.

Since the surface light source device 20 comprises the light guide plate 1, the surface light source device 20 is capable of emitting light at a higher luminance. Furthermore, since the transmission-type image display device 100 is illuminated by light with higher luminance that is emitted from the surface light source device 20, an image with high display quality such as an image with more vivid contrast can be displayed.

If the pattern is printed by the array of ink-jet heads (units) 5a-5c as shown in FIG. 12, there will appear linear luminance nonuniformity (striped unevenness) at connection part C between the inkjet heads (units) 5a-5c, because of their installation accuracy and position adjustment accuracy.

In the light guide plate 1 of the first embodiment, however, some of the light reflective dots 12 regularly arrayed in the two-dimensional pattern are eliminated as shown in FIG. 13; therefore, the linear luminance nonuniformity can be reduced at the connection part C between the ink-jet heads (units) 5a-5c.

In the light guide plate 1 of the first embodiment, the eliminating rate of the light reflective dots 12 is relatively small, 1% to 30%; therefore, the linear luminance nonuniformity at the connection part between the ink-jet heads (units) 5a-5c can be reduced without degradation of uniformity of luminance in the regions where the coverage is low as on the light incident sides near the light sources.

The present invention can be modified in various ways without having to be limited to the aforementioned embodiment. For example, the above embodiment illustrated the light distribution pattern in which some of the light reflective dot were irregularly eliminated, but it is also possible to adopt a light distribution pattern in which some of the light reflective dot are regularly eliminated.

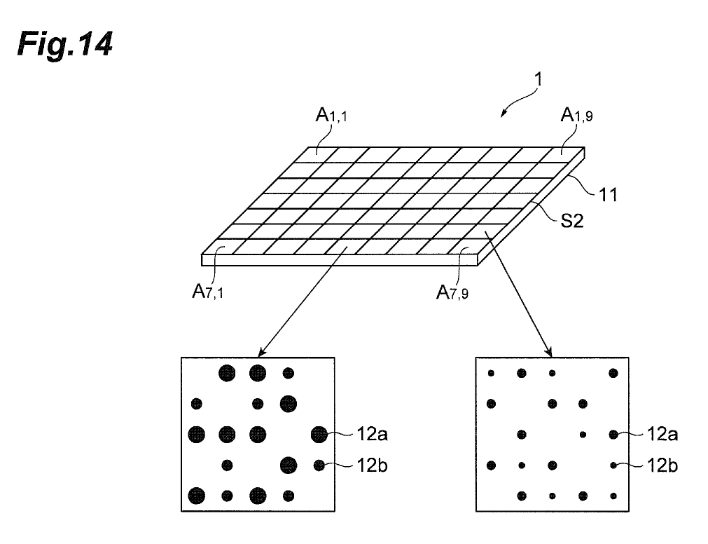

The above embodiment illustrated the light distribution pattern in which the light reflective dots 12 having the same size were distributed, but it is also possible to adopt an arrangement pattern in which light reflective dots 12a, 12b having two types of sizes are arranged in an irregular order, as shown in FIG. 14, or an arrangement pattern in which light reflective dots having three or more types of sizes are arranged in an irregular order.

When the light reflective dots having two or more types of sizes are arranged in an irregular order as described above, it is feasible to decrease change in gradation due to the light reflective dots. As a result, luminance nonuniformity can be reduced in the regions where the coverage of the light distribution pattern is low as on the light incident sides near the light sources. The effect is significant, particularly, in individual regions where the coverage of the light reflective dots is 50% or less.

The above embodiment showed the example in which the print surface of the light distribution pattern in the light guide substrate 11 was divided into 7×9 regions, but the print surface of the light guide substrate 11 can be divided into an arbitrary number of M×N regions A_{1,1}-A_{M,N} (where M and N are arbitrary integers of 2 or more).

The above embodiment showed the example in which the grid points P for printing targets were 5×5 points in each individual region A_{m,n}, but the number of grid points P can be set to an arbitrary number.

The above embodiment illustrated the configuration wherein the light sources 3 were arranged each beside the edge faces S3₁, S3₂ opposed to each other. However, it is only necessary to arrange the light sources 3 beside at least one edge face intersecting with the light exit surface S1 (or the rear face S2) of the transparent resin sheet 11.

The above embodiment illustrated the ink-jet printing, but the features of the present invention are applicable to any printing with a coupled array of multiple heads, such as laser printing.

### EXAMPLES

Samples of light guide plates 1 according to the embodiment of the present invention were manufactured experimentally as examples and comparative evaluation was conducted with a light guide plate of a comparative example. The light guide plates of the examples and comparative example were as described below.

### Example 1

A 600 mm×345 mm PMMA resin sheet was prepared as an optically transparent resin sheet and the light guide plate was manufactured using a UV curing type ink-jet ink containing calcium carbonate as a pigment.

Specifically, first, the rear face S2 of the light guide substrate 11 was divided into a plurality of regions and the coverage was set to 48% in each individual region (422.5 μm×422.5 μm). Next, for each individual region, 5×5 grid points regularly arrayed in a two-dimensional pattern were set as grid points for printing targets of light reflective dot. Next, for each individual region, the size and number of light reflective dot to be formed on the grid points were determined based on the coverage of 48%, the twenty five grid points, and the eliminating rate of light reflective dot of 4%. Then, for each individual region, a plurality of light reflective dot were arranged on the grid points in such a manner that some of light reflective dot were irregularly eliminated, based on the size and number of light reflective dot determined. In this manner, we obtained the light distribution pattern with the uniform coverage of 48%, with the eliminating rate of 4%, and in an irregularly eliminated state.

Next, a masking film was peeled off from the PMMA resin sheet and the resultant light distribution pattern was printed on the exposed surface by ink-jet printing with the UV curing type ink-jet ink. The ink-jet heads used herein were those having the nozzle-nozzle distance d1 of about 84.5 μm (cf. FIG. 13). Since the installation accuracy and position adjustment accuracy for the coupled array of ink-jet heads were about 15 μm, the nozzle-nozzle distance d2 at the connections between the ink-jet heads was set to about 99.5 μm. Then the printed ink-jet ink was irradiated with UV light, thereby achieving photocuring of the ink. Specifically, at 6 seconds after the pattern printing with the UV curing type ink-jet ink on the PMMA resin sheet, it was irradiated with UV light to be photocured. As a result, we obtained the light guide plate of Example 1 in which the light distribution pattern was formed with the uniform coverage of 48%, with the eliminating rate of 4%, and in the irregularly eliminated state.

### Example 2

The light guide plate of Example 2 was obtained in the same manner as in Example 1 except that the light distribution pattern was designed and formed with the eliminating rate of 10%.

### Example 3

The light guide plate of Example 3 was obtained in the same manner as in Example 1 except that the light distribution pattern was designed and formed with the eliminating rate of 20%.

### Example 4

The light guide plate of Example 4 was obtained in the same manner as in Example 1 except that the light distribution pattern was designed and formed with the eliminating rate of 30%.

### Example 5

The light guide plate of Example 5 was obtained in the same manner as in Example 1 except that the light distribution pattern was designed and formed with the eliminating rate of 50%.

### Example 6

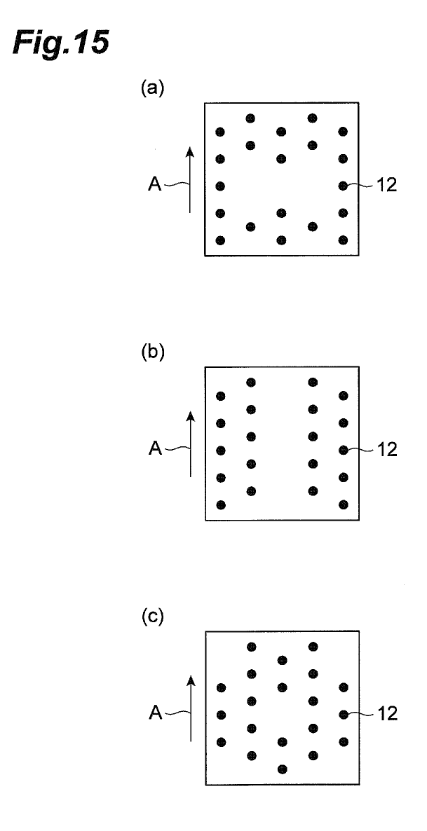

The light guide plate of Example 6 was obtained in the same manner as in Example 3 except that the light distribution pattern was designed and formed so as to regularly eliminate some of the light reflective dot. Specifically, as shown in FIG. 15 (a), the light distribution pattern was designed and formed so as to eliminate light reflective dot near the center, for each individual region.

### Example 7

Similarly, the light guide plate of Example 7 was obtained in the same manner as in Example 3 except that the light distribution pattern was designed and formed so as to regularly eliminate some of the light reflective dot. Specifically, as shown in FIG. 15 (b), the light distribution pattern was designed and formed so as to eliminate a line of light reflective dot in the printing direction A of the ink-jet heads, which was a line near the center, for each individual region.

### Example 8

The light guide plate of Example 8 was obtained in the same manner as in Example 3 except that the light distribution pattern was designed and formed so as to regularly eliminate some of the light reflective dot. Specifically, as shown in FIG. 15 (c), the light distribution pattern was designed and formed so as to eliminate light reflective dot near the center and at the four corners, for each individual region.

### Comparative Example 1

The light guide plate of Comparative Example 1 was obtained in the same manner as in Example 1 except that the light distribution pattern was designed and formed with the eliminating rate of 0%, i.e., without eliminating the light reflective dot.

In the present evaluation, each of the light guide plates of Examples 1 to 8 and Comparative Example 1 was incorporated in place of the diffuse film, prism film, DBEF, and light guide plate in a TV unit using LEDs as light sources. Then these TV units were turned on and striped unevenness (linear luminance nonuniformity) was visually evaluated (without the films of diffuse film, prism film, and DBEF). Furthermore, striped unevenness was also visually evaluated using the diffuse film, prism film, and DBEF (i.e., with the films). Furthermore, brightness of the light incident part was visually evaluated with the use of the diffuse film, prism film, and DBEF. The results of these evaluations are provided in Table 1 below.

TABLE 1

| | | | striped | striped | |
|---|---|---|---|---|---|
| | | | uneven- | uneven- | nonuniformity |
| | Elimi- | Elimi- | ness | ness | of luminance |
| | nating | nation | (without | (with | on light |
| | rate | method | films) | films) | entrance side |
| Example 1 | 4% | irregular | absent | absent | absent |
| Example 2 | 10% | irregular | absent | absent | absent |
| Example 3 | 20% | irregular | absent | absent | absent |
| Example 4 | 30% | irregular | absent | absent | absent |
| Example 5 | 50% | irregular | absent | absent | present |
| Example 6 | 20% | regular | absent | absent | absent |
| Example 7 | 20% | regular | absent | absent | absent |
| Example 8 | 20% | regular | absent | absent | absent |
| Comparative | 0% | — | present | present | absent |
| Example 1 | | | | | |

It was found by the above evaluation results that the striped unevenness (linear luminance nonuniformity) was reduced at the connections between the ink-jet heads, by eliminating some of light reflective dot in the light distribution pattern. According to the above evaluation results, the degree of reduction in striped unevenness was greater in Examples 1-5 based on the irregular elimination of light reflective dot than in Examples 6-8 based on the regular elimination of light reflective dot.

It was also found according to Example 5 that when the eliminating rate of light reflective dot was as large as 50%, nonuniformity of luminance became conspicuous in the regions where the coverage of the light distribution pattern was low as on the light incident sides near the light sources.

What is claimed is:

1. A light guide plate in which light reflective dot are formed on at least one surface of a light guide substrate,
wherein the plurality of light reflective dot are formed on grid points for printing targets, said grid points being regularly arrayed in a two-dimensional pattern, in each of individual regions obtained by dividing said at least one surface of the light guide substrate into the plurality of regions, and
wherein some of the light reflective dot are eliminated in each of the individual regions.

2. The light guide plate according to claim 1, wherein an eliminating rate of some of the light reflective dot is in the range of 1% to 30% of the number of the grid points.

3. The light guide plate according to claim 1,
wherein the plurality of light reflective dot include light reflective dot having two or more types of sizes, and
wherein the two or more types of light reflective dot are arranged in an irregular order.

4. A method of designing a light distribution pattern for a light guide plate, said light distribution pattern consisting of light reflective dot formed on at least one surface of a light guide substrate, comprising:
a coverage setting step of dividing said at least one surface of the light guide substrate into a plurality of regions and setting a coverage for each of the individual regions obtained by the dividing;
a grid point setting step of setting grid points for printing targets, said grid points being regularly arrayed in a two-dimensional pattern, for each of the individual regions;
a grid point calculation step of calculating a number of the grid points, for each of the individual regions;
an elimination number setting step of setting a size of the light reflective dot to be formed on the grid points, and an elimination number of the light reflective dot, based on the coverage and the number of grid points, for each of the individual regions; and
an arrangement step of arranging a plurality of light reflective dot on the grid points so as to eliminate some of the light reflective dot, based on the result obtained in the elimination number setting step.

5. The method according to claim 4, wherein the elimination number setting step comprises setting the elimination number of the light reflective dot in such a manner that an eliminating rate of some of the light reflective dot falls in the range of 1% to 30% of the number of the grid points.

6. The method according to claim 4,
wherein the elimination number setting step comprises setting the size of the light reflective dot to be formed on the grid points, in such a manner that the plurality of light reflective dot include light reflective dot having two or more types of sizes, and
wherein the arrangement step comprises arranging the plurality of light reflective dot in a such a manner that the two or more types of light reflective dot are arranged in an irregular order.

7. A light guide plate comprising the light distribution pattern designed by the method of designing the light distribution pattern for the light guide plate as set forth in claim 4.

8. A method of manufacturing a light guide plate in which a light distribution pattern consisting of light reflective dot is formed on at least one surface of a light guide substrate, using a printing device which has two or more units in which printing portions for printing are arrayed, and in which the units are arranged in an array direction of the printing portions,
wherein the light distribution pattern is designed by the method of designing the light distribution pattern for the light guide plate as set forth in claim 4, and
wherein the light distribution pattern is printed onto the light guide substrate by the printing portions of the units, while implementing relative movement of the units to the light guide substrate.

9. The method according to claim 8,
wherein the printing portions are nozzles,
wherein the units are ink-jet heads having an array of the nozzles, and
wherein the light reflective dot are comprised of an ultraviolet curing type ink-jet ink for the light guide plate.

10. A light guide plate manufactured by the method of manufacturing the light guide plate as set forth in claim 8.

11. A surface light source device of an edge light type comprising:
the light guide plate as set forth in claim 1; and
a light source for supplying a light to the end face of the light guide plate.

12. A transmission-type image display device comprising:
the surface light source device as set forth in claim 11; and
a transmission-type image display unit arranged opposite to an exit face of the surface light source device.
